(19) United States
(12) Patent Application Publication
(10) Pub. No.: US 2019/0205779 A1
(43) Pub. Date: Jul. 4, 2019

(54) Universal Functions Originator

(71) Applicant: Ali Ridha Ali, Halifax (CA)

(72) Inventor: Ali Ridha Ali, Halifax (CA)

(73) Assignee: Ali Ridha Ali, Halifax (CA)

(21) Appl. No.: 16/278,070

(22) Filed: Feb. 16, 2019

(51) Int. Cl. G06N 7/00; G06F 17/18; G06F 17/11

(52) U.S. Cl. CPC G06N 7/00; G06F 17/11; G06F 17/18

(57) ABSTRACT

Nowadays, many computing systems are used to perform many applications, such as: pattern classification, function approximation, categorization/clustering, control, forecasting/prediction, and optimization. Such these tools are linear regression (LR), nonlinear regression (NLR), artificial neural networks (ANNs), and support vector machines (SVMs). LR is used for simple data where the relation between its predictor and response vectors is linear, while NLR is used when that relation is not linear. ANNs and SVMs are more efficient and they can be used for complicated applications. However, each one of these approaches has its own strengths and weaknesses. This invention proposes a new computing system called universal functions originator (UFO). This system can generate highly complicated mathematical models, as well as simplifying them, automatically through two optimization stages. The four arithmetic operators (addition, subtraction, multiplication, and division) and all known mathematical functions (exponential, logarithmic, trigonometric, hyperbolic, etc.) can be included in the search space.

### TECHNICAL FIELD

Embodiments are generally related to statistical modeling, machine learning, and artificial intelligence; and more specifically, in function approximation and regression analysis.

### BACKGROUND OF THE INVENTION

Modern artificial intelligence (AI) is split into different fields, such as: 1. problem-solving, 2. knowledge, reasoning, and planning, 3. uncertain knowledge and reasoning, 4. communicating, perceiving, and acting, 5. learning, and 6. robotics.

Some of the tools used in AI are: 1. search and optimization, 2. artificial neural networks (ANNs), 3. logic, 4. statistical learning methods and classifiers, and 5. uncertain reasoning through probabilistic methods.

Each one of these tools is also divided into many sub- and sub-sub-tools. For example, optimization algorithms are categorized under three main sub-categories called: 1. classical, 2. meta-heuristic, and 3. hybrid optimization algorithms. Also, there are many sub-sub-categories under meta-heuristic optimization algorithms sub-category.

Similar to optimization field, neural network is a very hot topic in the literature. ANNs can be divided into two main types, which are: 1. feed-forward ANNs, and 2. recurrent/feedback ANNs. Each one of them also has multiple sub-types. Some of feed-forward ANNs are: single-layer perceptron (SLP), multilayer perceptron (MLP), time delay neural network (TDNN), probabilistic neural network (PNN), convolutional neural network (CNN), and autoencoder (AE). In the opposite side, Hopfield, self-organizing map (SOM), Boltzmann machine, learning vector quantization (LUQ), adaptive resonance theory (ART), echo state network (ESN), and long short-term memory (LSTM), all are some types of recurrent/feedback ANNs.

ANNs are used to perform many tasks, such as: 1. function approximation, 2. pattern classification, 3. categorization/clustering, 4. control, 5. optimization, and 6. forecasting/prediction. The first three applications are the core of what is now called a machine learning (ML).

ML is a major part of modern AI, which is exactly the fifth field listed in the paragraph number [0002]; i.e., learning. If an automatic feature extraction mechanism is embedded inside the learning stage, then this special ML algorithm is called a deep learning (DL).

The most popular ML algorithms are: 1. linear regression (LR), 2. nonlinear regression (NLR), 3. ANNs-based algorithms, 4. decision tree, 5. support vector machines (SVMs), 6. random forest, 7. k-means clustering, 8. naive Bayes classifiers, 9. k-nearest neighbors (kNN) classifier, 10. gradient boosting algorithms, and 11. dimensionality reduction algorithms.

Each one of these computing systems, listed in the paragraph number [0008], has its own strengths and weaknesses. For example, the analysis of LR is very simple and it is a straight-forward computing machine that can be used to quickly determine all the model coefficients. LR can be used to model optimization objective functions and constraints, or to have function approximation and deterministic forecasting/prediction models. These models are very simple and can be embedded easily in internal/external systems without using any significant memory. Furthermore, these polynomial-based models have some useful meanings, and the analysts can reveal many facts from intercepts, slopes, etc. However, there are many inevitable limitations associated with LR. One of the main inherent weaknesses of LR is that the relationship between the predictors and response is suppose to be linear, quadratic, cubic, or other polynomial orders.

To resolve the non-linearity issue of LR, some commercial/open-source software and programming packages allow users to defined their own nonlinear models before being fitted via some built-in optimization algorithms. That is, NLR analysis is implemented here instead of LR analysis. However, one of the biggest challenges faced in NLR is that it is very hard to define the non-linear model and choosing the initial values of its parameters and their lower and upper limits.

ANNs are commonly used to resolve the technical problems of NLR, because ANNs are more efficient and they can solve very complex problems. That is, ANNs can be used to avoid the inherent weaknesses of LR and NLR without building any mathematical expression. Although ANNs have many great capabilities, there are also some drawbacks. The first drawback is the preceding strength about dealing with any given data without constructing any mathematical model. This black box feature is actually a double-edged sword, because estimating output variables without referring to any mathematical function makes the whole process secret and nobody can know what is going on inside ANNs. Also, some of inherent weaknesses of ANNs are about the selection criteria of their topology, structure (number of neurons and hidden layers), learning algorithm, transfer functions, type of features, normalization phase, and geometrical interpretation. Moreover, ANNs require long CPU time to train the given data. Furthermore, a large amount of data is required with no guarantee to provide 100% reliability nor reaching optimal results.

The other alternative that can be used is SVM. This computing system is built based on statistical learning theory, which has a solid theoretical foundation. SVMs have the advantage of adaptability, theoretical completeness, global optimization, and good generalization ability. Some of the main weaknesses of SVMs are the selection of kernel functions and their parameters. Moreover, the size and speed required to train and test data are high. In addition, another barrier can be faced with discrete data. Furthermore, SVMs have poor result transparency.

The invention presented here is an alternative computing system that could be used to solve some of inherent weaknesses of the preceding computing systems. The new computing system is called a universal functions originator (UFO). This system can generate highly complicated mathematical equations as well as simplifying existing complicated functions down to some very simple and compact functions.

The UFO computing system uses two optimization stages, and it can accept any type of functions (polynomial, exponential, trigonometric, logarithmic, hyperbolic, inverse trigonometric, inverse hyperbolic, etc.). Also, universal operators are used between terms and functions, where these operators could be the basic ones (addition, subtraction, multiplication, and division) or any other hybrid- or fuzzy-based operators.

The UFO computing system has been designed and tested with many problems, and it shows some impressive results with many promising capabilities. Some of these numerical results are presented. Also, the main capabilities and advantages are listed.

### BRIEF DESCRIPTION OF THE DRAWINGS

FIG. 1 describes the basic block-diagram of UFO with only one output stream.

FIG. 2 illustrates the block-diagram of UFO with one output stream when only addition operators are used between blocks.

FIG. 3 illustrates the same block-diagram shown in FIG. 2 when the operators between the blocks are variable; i.e., universal operators.

FIG. 4 illustrates the same block-diagram shown in FIG. 3 when recurrent streams are connected between blocks; which is called a recurrent universal functions originator (RUFO).

FIG. 5 describes the basic block-diagram of UFO with m output streams.

FIG. 6 illustrates the mechanism of UFO with multiple output streams when universal operators are used.

FIG. 7 shows one approach to hybridize UFO with LR and NLR.

FIG. 8 shows one approach to hybridize UFO with SVMs.

FIG. 9 shows one approach to hybridize UFO with ANNs.

FIG. 10 shows one approach to hybridize UFO with ANNs and SVMs.

FIG. 11 shows some other possible approaches to hybridize UFO with SVMs.

FIG. 12 shows some other possible approaches to hybridize UFO with ANNs.

FIG. 13 shows some other possible approaches to hybridize UFO with ANNs and SVMs.

FIG. 14 lists some approximated functions to estimate one over x; when x varies from 0.2 to 0.8 in small steps. These function approximations are generated by UFO shown in FIG. 3 with using only one block; i.e.,

FIG. 15 lists some approximated functions to estimate one over x; when x varies from 0.2 to 0.8 in small steps. These function approximations are generated by UFO shown in FIG. 3 with using two blocks; i.e., B₁ and B₂.

FIG. 16 lists some approximated functions to estimate one over χ; when χ varies from 0.2 to 0.8 in small steps. These function approximations are generated by UFO shown in FIG. 3 with using three blocks; i.e., B₁, B₂ and B₃.

FIG. 17 lists some approximated functions to estimate one over χ; when χ varies from 0.2 to 0.8 in small steps. These function approximations are generated by UFO shown in FIG. 3 with using five blocks; i.e., B₁, B₂, B₃, B₄ and B₅.

FIG. 18 lists three approximated functions to estimate a data composed of one response and four predictors. These function approximations are generated by UFO shown in FIG. 3 with using twelve blocks; i.e., B₁ B₁₂.

FIG. 19 shows how the original function given in 141 of FIG. 14, i.e. one over χ, can be approximated using the structure shown in FIG. 7 with twenty blocks; i.e., B₁-B₂₀. The symbols βs are the regression coefficients. This is just one possible approximation. For each new run, UFO will generate another new function approximation.

FIG. 20 shows how to approximate the data given in FIG. 18 using the structure shown in FIG. 7 with twenty blocks; i.e., B₁-B₂₀. The symbols βs are the regression coefficients. Similar to FIG. 19, the model shown in FIG. 20 is just one possible approximation. For each new run, UFO will generate another new function approximation.

### DETAILED DESCRIPTION

Suppose a data consists of one response (i.e., one output variable) and n predictors (i.e., n input variables). If f denotes the function used to approximate that output variable based on the n input variables, then the approximated response ŷ can be mathematically expressed as follows:

ŷ=f(χ₁, χ₂, . . . , χₙ); k=1, 2, . . . , n (Eq. 1)

Eq. 1 can be solved by LR if f=1×( ) and there is no non-linearity between regression coefficients. If the coefficients are nonlinear and/or f≠1×( ), then NLR should be implemented with defining the initial guess of its coefficients manually by the user herself/himself.

The function f given in Eq. 1 could be represented by any known mathematical function. For example, a basic function (such as: 1×( ),

$$\frac{1}{( )} ,$$

∥, [symbol] , ␣, [symbol] . \sqrt{( )}, ( )!, ( ) ! !, etc.), a hyperbolic function (such as: sinh ( ), cosh ( ), tanh ( ), etc.), a trigonometric function (such as: sin ( ), cos ( ), tan ( ), etc.), an exponential or a logarithmic function (such as: exp ( ), ln ( ), log₂ ( ), log₁₀ ( ), etc.), or any other function including unfamiliar (such as: exsec ( ), excse ( ), versin ( ), vercos ( ), coversin ( ), covercos ( ), sinc ( ), si ( ), Si ( ), Ci ( ), Cin ( ), Shi ( ), Chi ( ), etc.).

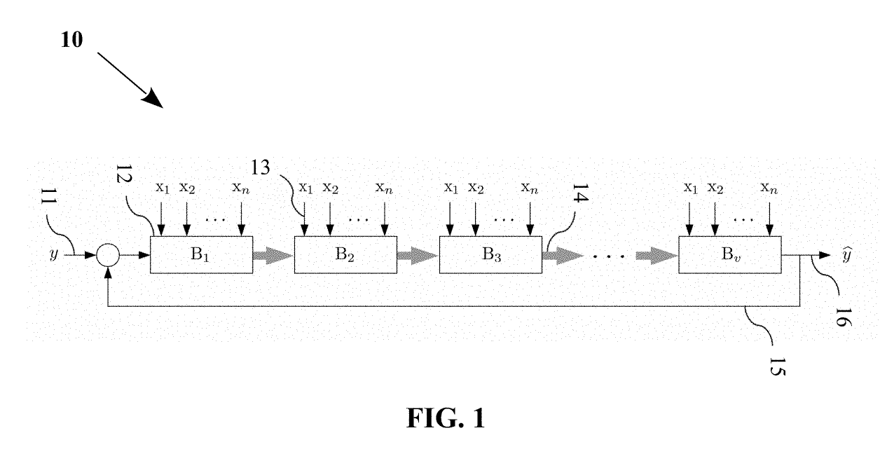

Instead of using just one function f, as in Eq. 1, suppose the regressed response is decomposed into v functions {f₁, f₂, . . . , fⱼ, . . . , fᵥ}. Then, the whole problem can be depicted in the block-diagram shown in 10 of FIG. 1, where each jth function occupies one block 12 and receives all n predictors 13. The thick arrows 14 mean that the information flows from the left side to the right side.

The block-diagram shown in 10 of FIG. 1 acts like a feedback-control system where the actual response y can be considered as a set-point 11 and the regressed response ŷ can be considered as a process variable 16.

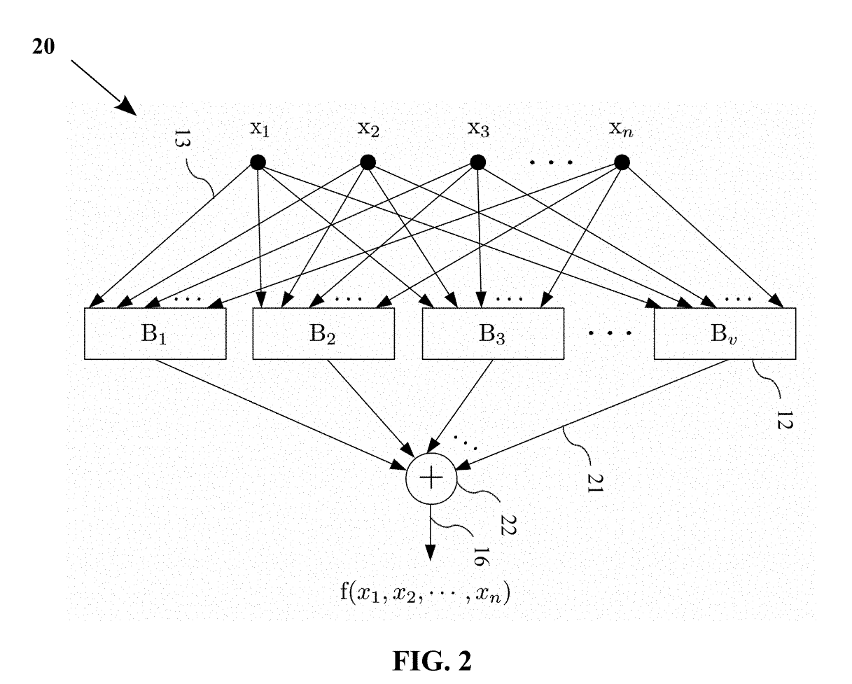

Now, suppose the recycle stream 15 is opened and the error between y and ŷ is minimized through an external tool with no any delay between 11 and 16. Also, instead of multiplying the v blocks 12, suppose there is an uncertainty on each multiplication operator. If an addition operator is placed between each two blocks 12 instead of multiplying them, then FIG. 2 shows the modified block-diagram where 21 is the output of each block 12 and 22 represents the addition operators between these v blocks.

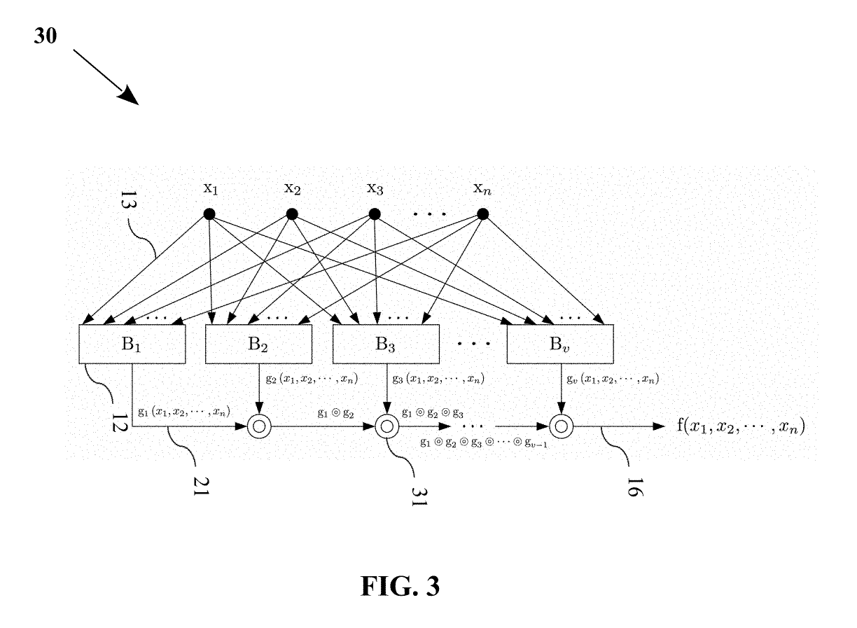

To generalize the preceding uncertainty phenomenon, all the four basic arithmetic operators {+, −, ×, ÷} can be used between the blocks. The other operators, including those used in fuzzy systems, could also be used here. Thus, a universal block-diagram can be illustrated in 30 of FIG. 3, where 31 represents the universal operators used between the blocks. If only an addition operator is placed in all ⊚, then FIG. 3 can be converted to FIG. 2. Similarly, if only a multiplication operator is used, then FIG. 1 can be obtained where the thick arrows 14 represent the multiplication operators placed between the blocks and the recycle stream 15 is opened.

Now, suppose each jth block 12 is represented by a function gⱼ(X); where X=[χ₁, χ₂, . . . , χₖ, . . . , χₙ], (k=1, 2, . . . , n) and (j=1,2, . . . , v). If each jth decomposed function fⱼ has an exponent cⱼ and it is multiplied by a weight wⱼ, then the relation between fⱼ and gⱼ can be mathematically explained as follows:

gⱼ(X)=wⱼ·[fⱼ(a_{0.j}⊙_{1,j}a_{1,j} χ₁^{b}^{_{1,j}}⊙_{2,j}a_{2,j}·χ₂^{b}^{_{2,j}}⊙_{3,j}. . . ⊙_{n,j}a_{n,j}·χₙ^{b}^{_{n,j}})]^{c}^{ⱼ} (Eq. 2)

where
⊙_{k,j}:the kth arithmetic operator assigned to the jth block Bⱼ for the kth predictor. If only the four basic arithmetic operators {+, −, ×, ÷} are used, then ⊙_{k,j}∈[1,4]. Otherwise, the upper limit should be equal to the length of the new arithmetic operators set.
fⱼ: the function assigned to the jth block Bⱼ. It could be any known or user-defined mathematical function, including those presented in the paragraph number [0038].
wⱼ: the weight assigned to the jth block Bⱼ; where wⱼ∈[wⱼ^{min}, wⱼ^{max}].
a_{0,j}: the intercept of the jth block Bⱼ; where a_{0,j}∈[a_{0,j}^{min}, a_{0,j}^{max}].
a_{k,j}: the kth coefficient assigned to the jth block Bⱼ for the kth predictor; where a_{k,j}∈[a_{k,j}^{min}, a_{k,j}^{max}].
b_{k,j}: the kth exponent assigned to the jth block Bⱼ for the kth predictor; where b_{k,j}∈[b_{k,j}^{min}, b_{k,j}^{max}].
cⱼ: the exponent assigned to the jth function fⱼ located in the jth block Bⱼ; where cⱼ∈[cⱼ^{min}, cⱼ^{max}].

Thus, by decomposing f(X) into v functions with considering universal operators 31 between each two blocks, Eq. 1 can be replaced with the following one:

ŷ=f(X)=g₁(X) ⊚₁g₂(X) ⊚₂ . . . ⊚ᵥ₋₁gᵥ(X) (Eq. 3)

Also, Eq. 2 can be replaced with other more complicated expressions, like embedding a function in each internal exponent b_{k,j} and/or external exponent cⱼ. But this track will complicate the numerical problem and its dimension will be increased. Thus, let's just focus on Eq. 2 to explain the mechanism of the UFO computing system.

By referring to FIG. 3, Eq. 2 and Eq. 3, it can be recognized that the symbols ⊙ and ⊚ are actually same. The first one is used internally between the predictors of each jth function fⱼ, and the other is used externally between the blocks.

The optimal sets of ⊙ and ⊚ can be obtained via a mixed-integer optimization algorithm. For this mission, there are “v” variables of type {w, f, a₀, e}, “v×n” variables of type {⊙, aₖ, bₖ}, and “v−1” variables of type ⊚.

This highly non-linear and non-convex mixed-integer optimization problem can be solved by using a special strategy where both global and local optimization techniques are required to be implemented in different stages with different dimensions.

The global optimization stage can be built by using any meta-heuristic optimization algorithm; or by using just a random generator to expedite the process. The goal here is to repeatedly compose all gⱼ(X) functions given in Eq. 2 in order to build the overall mathematical function f(X) given in Eq. 3, and then searching for the best model via that global optimizer. The optimization problem in this stage is a mixed-integer where {f, ⊙, ⊚} are variables.

The goal of using the local gradient-based optimization algorithm is to tune the functions generated in the global stage. Here, {f, ⊙, ⊚} are fixed, and thus it is not a mixed-integer optimization algorithm; unless discrete exponents are required.

Based on that, the dimensions of both optimizers depend on the number of predictors n and the number of blocks v involved in UFO.

For the global mixed-integer optimization stage, its dimension [symbol] can be computed through the following formula:

[symbol]

=3vn+5v−1 (Eq. 4)

For the local gradient-based optimization stage, its dimension [symbol] can be computed through the following formula:

[symbol]

=2vn+3v (Eq. 5)

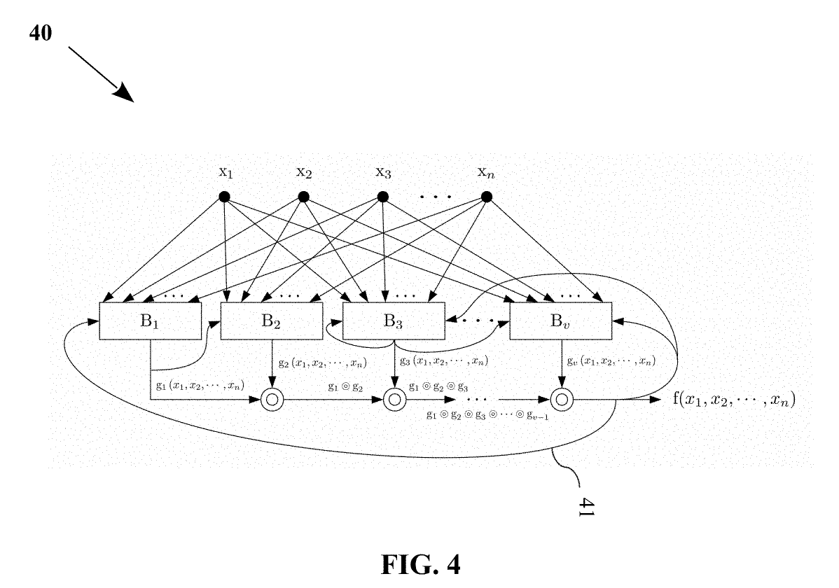

The UFO structure given in 30 of FIG. 3 can be complicated by adding some recurrent streams between its v blocks. Thus, different recurrent UFO (or RUFO) structures can be introduced too. One of these RUFO structures is shown in 40 of FIG. 4, where 41 represents one of these recurrent streams.

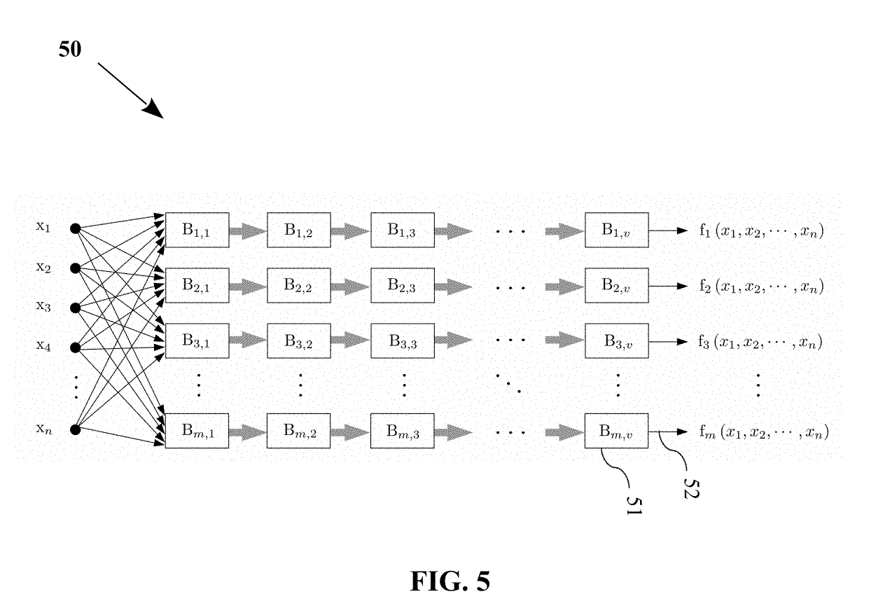

In case the given data has multiple responses that need to be approximated, then the block diagrams shown in FIG. 1-4 need to be re-designed to accept multiple output streams. For example, the basic block-diagram shown in FIG. 1 can be upgraded to FIG. 5 in order to accept m output variables or responses; as shown in 52 of FIG. 5. Thus, there are m rows, and each row contains v blocks. This can be observed by looking to 12 of FIGS. 1 and 51 of FIG. 5.

It can be clearly seen that FIG. 5 is identical with FIG. 1, but with multiple output streams. Thus, similar things can be observed here. Firstly, FIG. 5 represents one of the simplest structures of UFO. The information flows from the left side to the right side, which means that there is no any recurrent stream between the blocks of the same row. Secondly, these rows are not interconnected between each others, which is impossible with any existing ANN; because the knowledge is distributed between neurons and thus the interconnection in ANNs is inevitable. In the opposite side, the rows in UFO can be either isolated or partially/completely interconnected.

Now, let's assume that, for UFOs with multiple outputs, each block is denoted as B_{i,j} where the subscripts i and j are respectively equal to (i=1, 2, . . . , m) and (j=1, 2, . . . , v). Based on that, gⱼ and fⱼ of Eq. 2 will respectively become g_{i,j} and f_{i,j}. Also, the overall mathematical expression f given in Eq. 3 will become fᵢ for each ith row.

Therefore, for multiple responses, Eq. 2 must be upgraded as follows:

g_{i,j}(X)=w_{i,j}·[f_{i,j}(a_{0,i,j}⊙_{1,i,j}a_{1,i,j}·χⱼ^{b}^{_{1,i,j}}⊙_{2,i,j}a_{2,i,j}·χ₂^{b}^{_{2,i,j}}⊙_{3,i,j} . . . ⊙_{n,i,j}a_{n,i,j}·χₙ^{b}^{_{n,i,j}})]^{c}^{_{i,j}} (Eq. 6)

Similar thing can be done here for Eq. 3. Thus, to estimate the ith response, the following mathematical expression should be used in the basic UFO structure:

fᵢ(X)=g_{i,1}(X) ⊚_{i,1}g_{i,2}(X) ⊚_{i,2} . . . ⊚_{1,v-1}g_{i,v}(X) (Eq. 7)

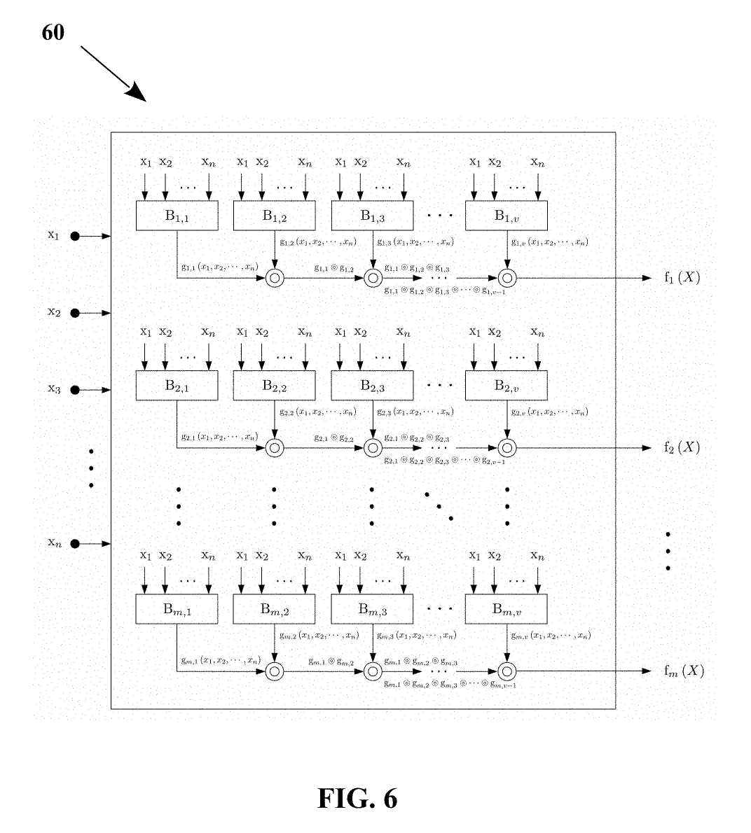

The whole process can be graphically explained via the block-diagram shown in 60 of FIG. 6, which is an upgraded version of that shown in 30 of FIG. 3.

The optimization problem dimensions of the basic UFO structure given in 60 of FIG. 6 can be calculated using the following two formulas:

[symbol]

=3mvn+5mv−m (Eq. 8)

[symbol]

=2mvn+3mv (Eq. 9)

where, as said before in the paragraphs number [052] and [053], the symbol [symbol] is denoted for the dimension of the global optimization algorithm, and [symbol] is denoted for the dimension of the local gradient-based optimization algorithm, and [symbol] > [symbol] .

The recurrent version of UFO, i.e. RUFO, given in FIG. 4 can also be applied here for FIG. 6. Again, the problem will be more complicated and the dimensions of both global and local optimization stages will increase.

The overall mechanism of any UFO type can be divided into four main stages: 1. Initialization Stage, 2. Building Stage, 3. Tuning Stage, and 4. Testing and Validation Stage.

Initialization Stage: different types of mathematical functions (exponential, logarithmic, trigonometric, hyperbolic, etc.) can be selected to enter the pool. Also, different types of arithmetic operators can enter the pool, which can be used to define the internal and external universal arithmetic operators. Based on that, the size and quality of that pool depend on the functions and arithmetic operators selected by the user. Also, the problem complexity can be affected by the quantity and quality of those functions selected in this stage and the number of blocks and rows used UFO. Furthermore, this stage is responsible to define the lower and upper limits of all the variables listed in Eq. 2 and Eq. 6, and all the other settings of UFO and the embedded optimization algorithms.

Building Stage: by using any global mixed-integer optimization algorithm (including meta-heuristic algorithms), UFO can generate infinite functions by substituting Eq. 6 in Eq. 7 for g_{i,j}(X). If (m=1), then i is always equal to one. This means that Eq. 6 and Eq. 7 will automatically become Eq. 2 and Eq. 3, and thus UFO with a one output stream is implemented here. Even if {w, b, c} are not discrete, a mixed-integer optimization algorithm must be used in this stage, because the function and the internal and external universal arithmetic operators {f, ⊙, ⊚} are always discrete. To simplify this stage and accelerate its speed, the preceding optimization algorithm can be replaced with just few programming lines to generate random solutions per each iteration. This action might also enhance the exploration level of this stage; where most of the exploitation level is shifted to the tuning stage.

Tuning Stage: the purpose of the building stage is to act as a function generator. Thus, the functions generated in that stage could need a further fitting. To satisfy that, a local gradient-based optimization algorithm is used to fit the functions generated in the building stage. There are many classical algorithms can be used for the tuning stage, such as Levenberg Marquardt and trust region reflective algorithms or any other gradient-based algorithm. The initial values obtained by the global optimizer of the building stage are used as the starting point in the local optimizer of the tuning stage. This stage should be equipped with a mixed-integer optimizer if any one of {w, b, c} is selected to be discrete. Otherwise, a normal float optimizer should be used, because {⊙⊚, f} determined in the building stage remain constant in the tuning stage.

Testing and Validation Stage: to evaluate the performance obtained in the last two stages of UFO, i.e. the building and tuning stages, the original data is split into three parts. The biggest one is used to build functions and tuning them. The remaining two portions are used for the testing and validation purposes. Although this stage can be disabled, it is very important to enable it in order to avoid the over-fitting phenomenon.

It is very crucial that all the points of the approximated response, obtained by UFO, should satisfy the following constraints:
They should not be infinite (i.e., ±∞),
They should not be complex (i.e., a±ib); unless the original problem is complex,
They should not be undefined (i.e., 0/0, 0×∞.

$$\frac{∞}{∞} ,$$

∞−∞).

To compare UFO with ANN, there are many major differences between these two computing systems. Some of these differences, that make UFO totally different than ANN, are:
The neurons of ANNs contain only weights and biases. In UFO, the blocks contain external weights w_{i,j}, intercepts a_{0,i,j}, internal weights a_{k,i,j}, internal exponents b_{k,i,j}, external exponents c_{i,j}, and unfixed functions f_{i,j}. Moreover, these internal and external exponents could be defined as fixed values or can be defined as embedded functions for more complicated and highly advanced UFO structures.
ANNs use normalized weights, while all the coefficients (weights, intercepts, and exponents) of UFO are not. Furthermore, the block weights w_{i,j}, the predictor exponents b_{k,i,j}, and the function exponents c_{i,j} can be set as discrete or as float variables. Moreover, when w_{i,j} are switched to the discrete mode, there is a possibility that some jth blocks of each ith row could be completely disabled and thus neglected during building the overall function fᵢ of the ith response.
In UFO, having an interconnection between some or all blocks of different rows is an optional feature, because each ith row can work independently without referring to any connection with any other rows. In the opposite side, the interconnection in ANNs is inevitable.
In ANNs, there is one optimization algorithm used in the training phase. In UFO, two different optimization algorithms with different dimensions are used to built functions and tune their parameters. The first one is a global mixed-integer optimization algorithm and the second one is a local gradient-based optimization algorithm that could be a mixed-integer or a floating-based type.
With fixing the data size and the number of hidden layers in ANNs, the dimension can still increase by increasing the number of neurons. In UFO, the dimensions of its global and local optimizers remain constant once the number of blocks v is defined.
ANNs act as black-boxes where the knowledge is distributed among many processing elements, while UFO represents it in readable mathematical equations.

Besides the differences between UFO and ANNs, UFO has many wonderful strengths. Some of its powerful properties are listed below:
The results generated by UFO are understandable and readable.
UFO can generate very simple as well as very complex mathematical equations, which can be used to reveal some phenomena and to discover some facts hidden behind the data.
These mathematical equations can be exchanged with other analysts and users either as a printed format or as an electronic format. In ANNs, the other users should have the same programming language or they are forced to import ANNs through what is called an Open Neural Network Exchange (ONNX).
Thus, the UFO results can be transferred to any one as hard-copy, email, picture, fax, file hostings (DropBox, Google Drive, Apple iCloud, Microsoft OneDrive, etc.).

Because the outputs of UFO are just mathematical equations, so they can be implemented by using many programming languages, MS Excel and other commercial/open-source alternatives, any scientific calculator, or even by hands.
If the UFO results are electronically saved. Then, it can be saved in many digital formats, including text formats.
Also, the file size of any UFO mathematical equation is very limited; just tens or hundreds of bytes based on the values of {m, n, v} set in UFO.
UFO can be implemented for both small and big data.
In UFO, the problem of feature selection, faced in many AI computing systems, is solved automatically, because it is an integral part of UFO.
The extracted mathematical equations from UFO can be used for many applications;

some of these applications are covered in the next paragraph.

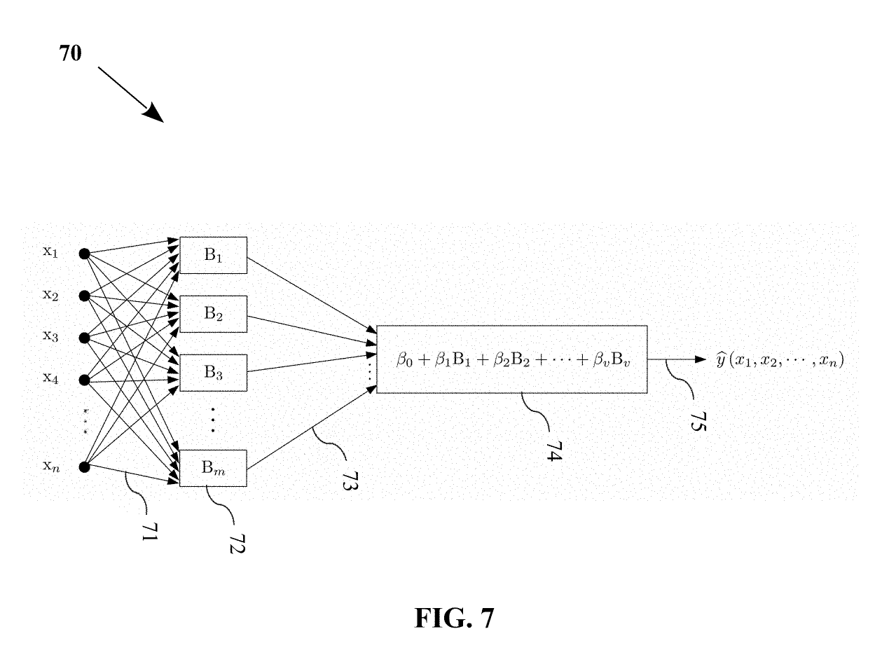

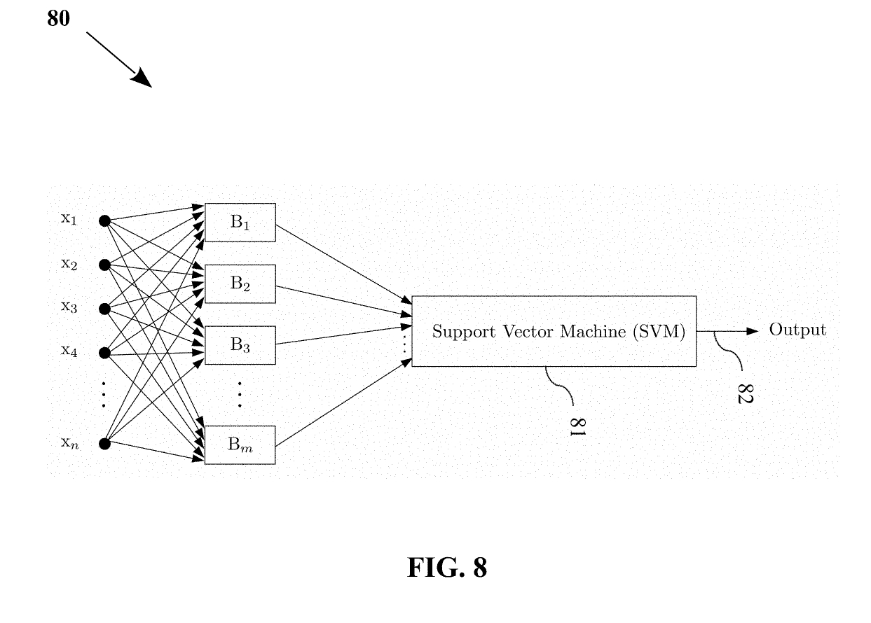

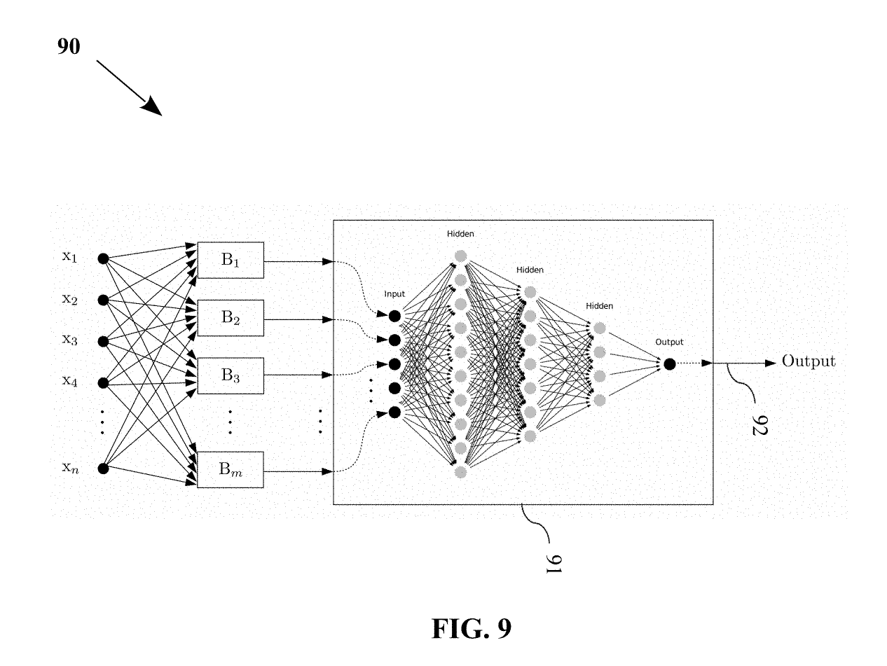

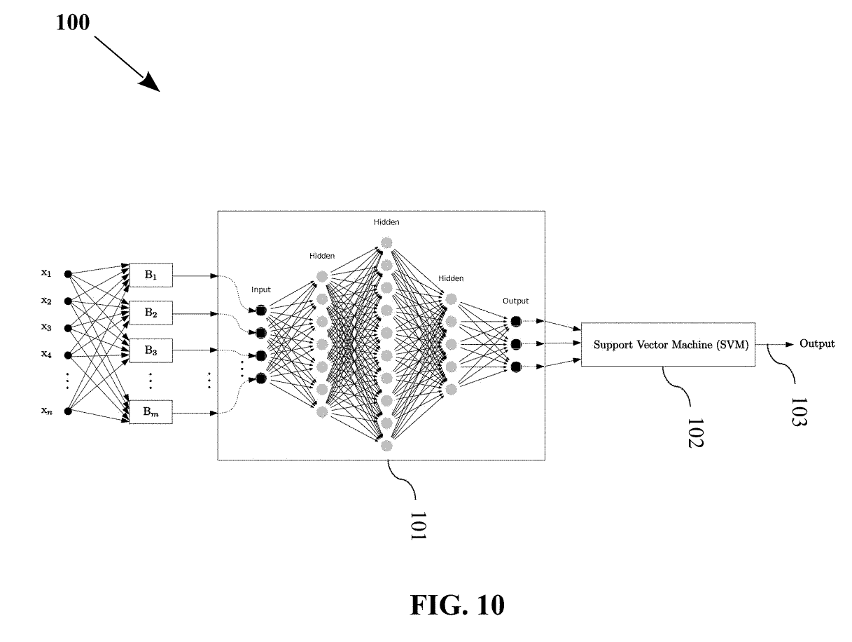

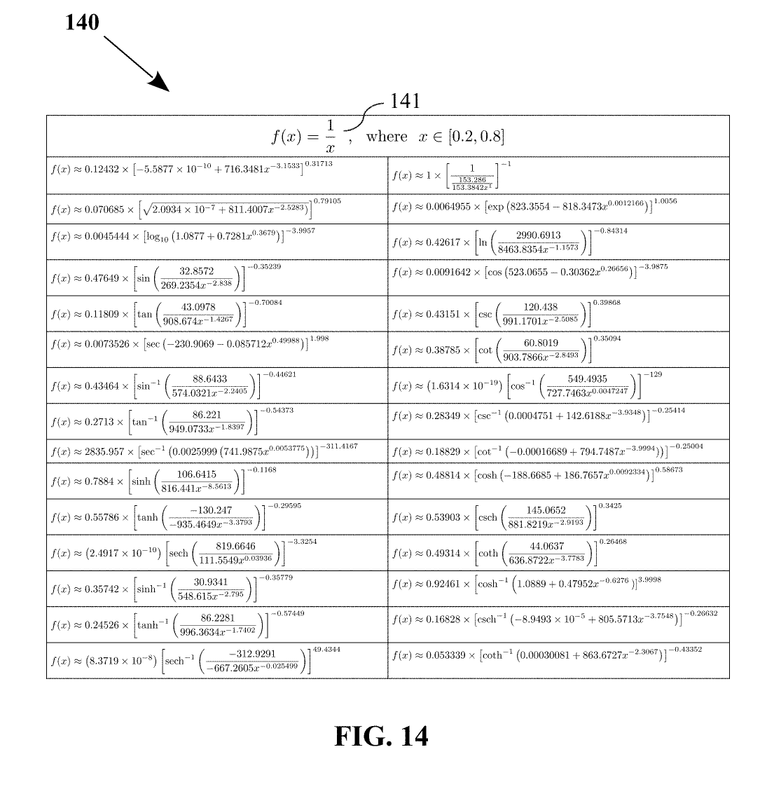

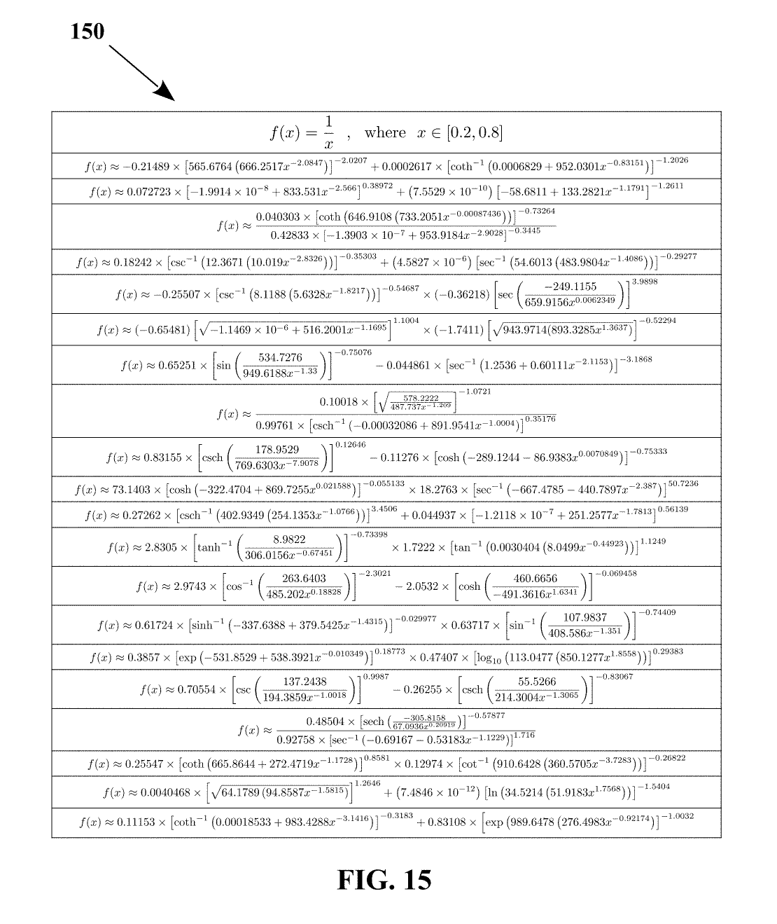

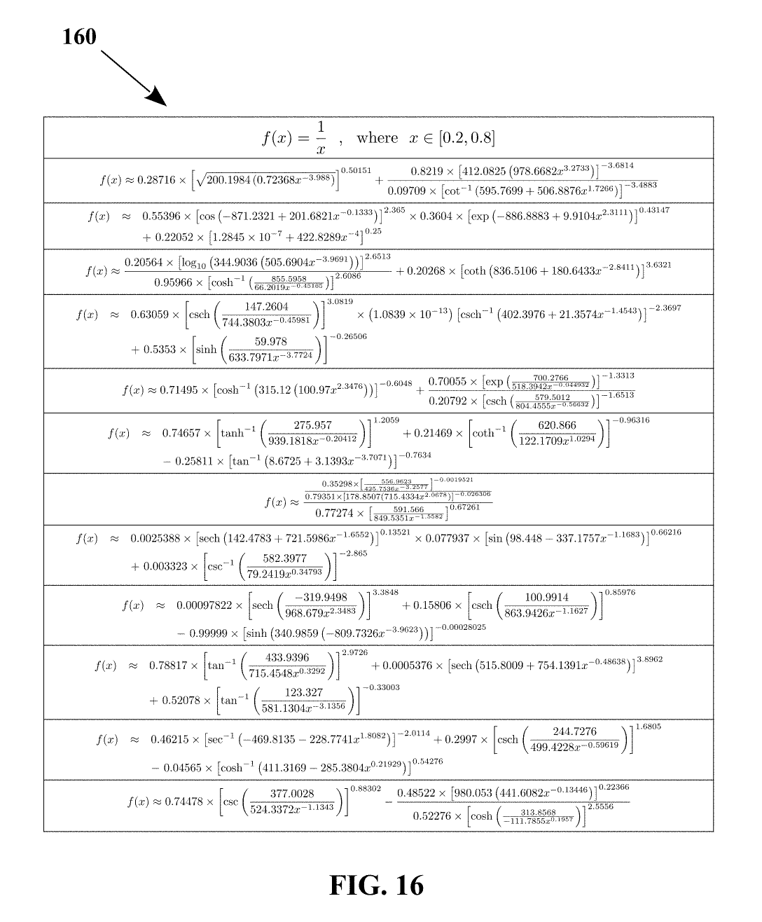

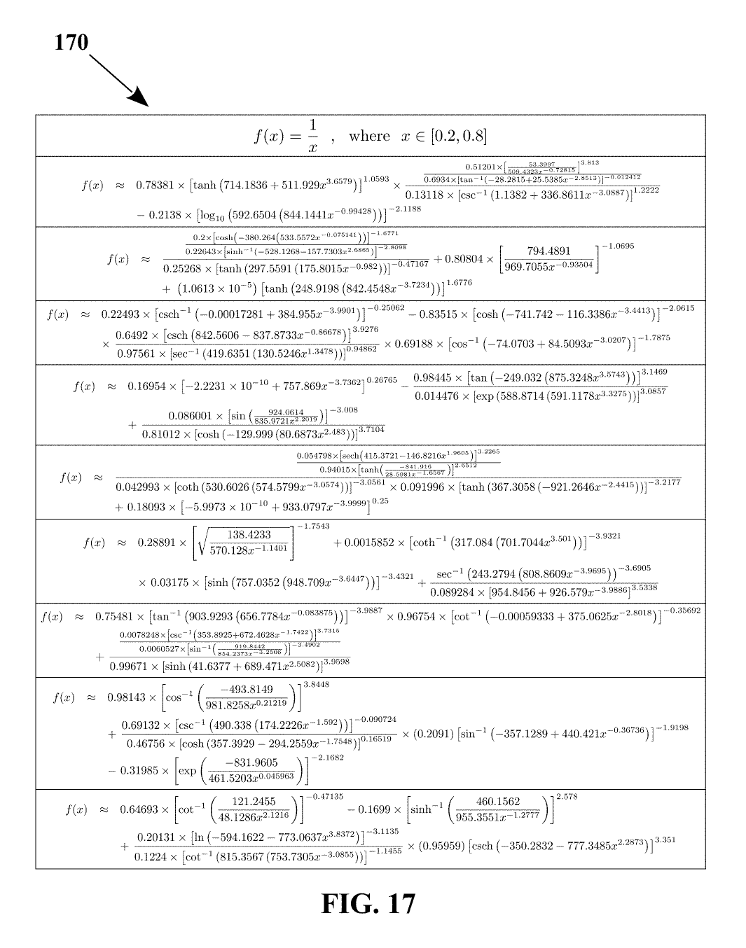

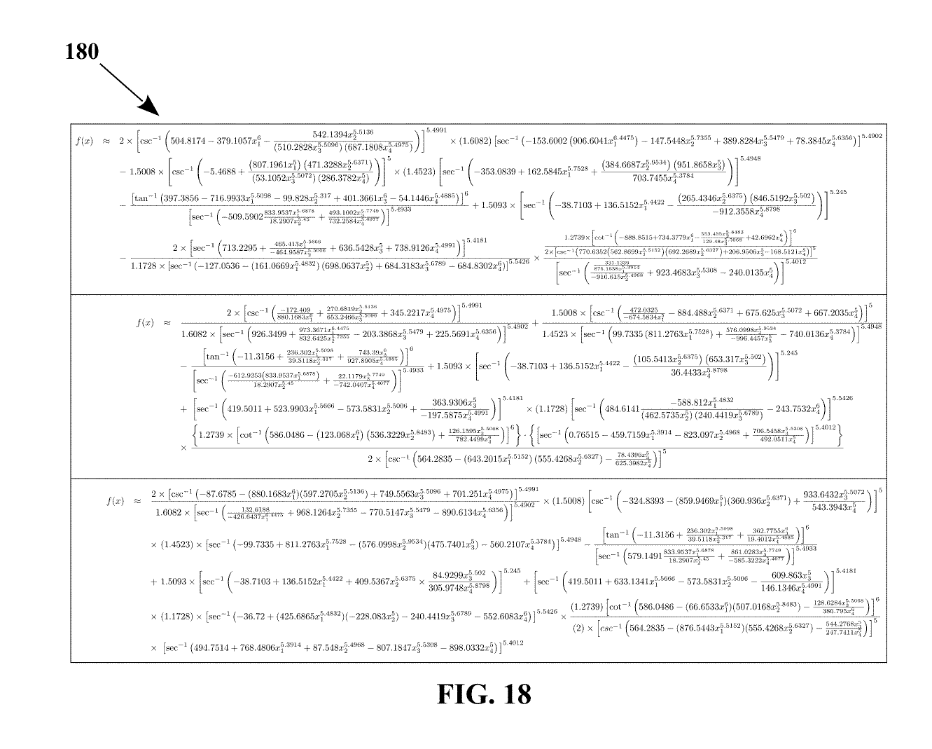

Because UFO is not a black-box computing system, where its results can be represented as readable mathematical equations, so this invention can be applied for a wide range of applications in almost all computation-based disciplines (including: mathematics, computer and data science, medical science, engineering, physics, space, astronomy, business and economics, etc.). Some of distinct capabilities and abilities of UFO are listed below:
UFO can be easily used as an effective tool in any optimization algorithm. UFO can act as a function approximation unit to convert real data to some mathematical models that can be used as objective functions or/and design constraints.
Instead of using linear and piecewise linear models to solve non-linear control problems, UFO can be used to generate highly precise functions to describe the non-linearity behavior of the real problems under study.
UFO can translate real data to meaningful linear/non-linear mathematical equations.
UFO can act as a universal general purpose regresser to fit any given data automatically without any manual adjustment, such as: polynomial model (1^{st} order, 2^{nd} order, 3^{rd} order, etc.), mode (linear or non-linear), number and type of predictors, number and type of functions, etc.
UFO can be used in clustering and categorization applications.
UFO can be used in anomaly detection applications.
UFO can be used as a new forecasting tool.
UFO can act as a simplifer to convert a ready-made complicated model into a very simple mathematical equation with preserving its accuracy. This can be done by using a very limited number of blocks v.
Conversely, by setting v to a very large value, UFO can act as a complicator. Thus, a very simple model can be replaced with a very complicated mathematical equation. For example, in 140 of FIG. 14, a simple one-dimensional problem 141 (i.e., one over χ; where χ moving from 0.2 to 0.8 in small steps) can be estimated by different mathematical models generated via UFO with one block (i.e., v=1). In 150 of FIG. 15, UFO has been used to approximate 141 by many functions when two blocks (i.e., v=2) are involved. In 160 of FIG. 16, UFO has been initiated with three blocks (i.e., v=3) to approximate the original function 141. By using five blocks (i.e., v=5), UFO can complicate the original function 141 more than before. This can be seen in 170 of FIG. 17. If there are more than one predictor, then highly complicated mathematical equations can be generated by setting v to a large value. For example, 180 of FIG. 18 shows three complicated functions that were generated by UFO with (v=12) for a data composed of four predictors.
One of the possible applications of UFO when it acts as a simplifier can be seen in 16 of FIG. 2 and in the UFO part of the structures shown in 70 of FIG. 7, 80 of FIG. 8, 90 of FIG. 9, 100 of FIG. 10. That UFO part gives the ability to reduce the dimension of high-dimensional optimization objective functions and constraints to low-dimensional equivalent models. This can be done by changing the n original predictors 71 to in new predictors 73 through m UFO blocks 72, where in should be smaller than n. If m is bigger than n, then the dimension of the new models (16 of FIG. 2 for pure UFO, 75 of FIG. 7 if UFO is hybridized with LR/NLR 74, 82 of FIG. 8 if UFO is hybridized with SVM 81, 92 of FIG. 9 if UFO is hybridized with ANN 91, and 103 of FIG. 100 if UFO is hybridized with ANN 101 and SVM 102) will be higher. Thus, reducing the problem dimension by UFO could increase the CPU time and accelerate finding the optima within less number of iterations.
Also, 16 of FIG. 2 and the UFO part of the structures shown in 70 of FIG. 7, 80 of FIG. 8, 90 of FIGS. 9, and 100 of FIG. 10 give the ability to visualize high-dimensional functions in two-dimensional (2D) and three-dimensional (3D) plots. This can be easily done by fixing (m=1) for 2D visualization and (m=2) for 3D visualization. Thus, there is only one new predictor g₁(X) for 2D visualization, and there are two new predictors {g₁(X), g₂(X)} for 3D visualization. These two new predictors can be calculated using Eq. 2.

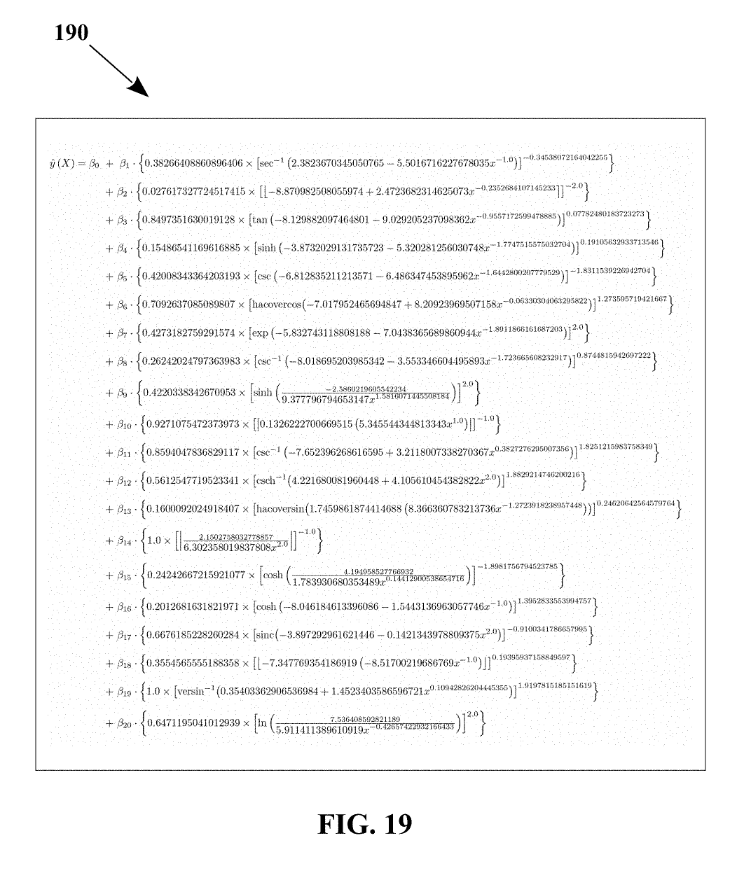

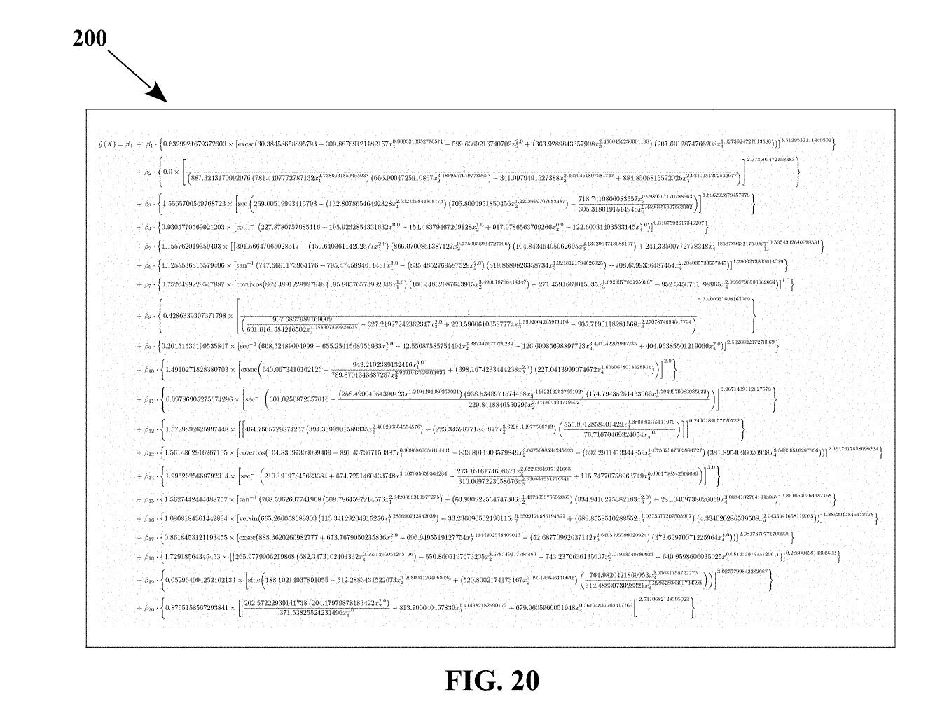

UFO can be hybridized with LR and NLR to generate other kinds of highly precise models. The hybrid structure depicted in 70 of FIG. 7 shows how UFO can be utilized to have a universal transformation unit for LR and NLR analysis. As can be clearly seen from that figure, the n original predictors 71 are universally transformed through UFO 72 to produce In new predictors 73. Each UFO block of 72 can be defined by Eq. 2. The approximated model 75 depends on the type of regression model used in 74; whether it is LR or NLR. Also, the hybrid system shown in 70 of FIG. 7 can simplify the models if (n>m) or complicate the models if (n<m). For example, 190 of FIG. 19 shows how the original equation given in 141 of FIG. 14 (n=1) can be complicated by setting (m=20), where βs are the regression coefficients when LR is used. If the data approximated in 180 of FIG. 18 (n=4) is used here with (m=20) and LR, then one of the models approximated by the hybrid structure shown in 70 of FIG. 7 is shown in 200 of FIG. 20.

UFO can also be hybridized with SVM. One of the possible hybrid designs is shown in 80 of FIG. 8, where the SVM part is 81 and the estimated response is 82. Based on some numerical experiments, it has been found that this structure can help SVMs equipped with very basic kernel functions to compete with highly advanced SVMs, because all the non-linearity of the data are left to the UFO part to deal with.

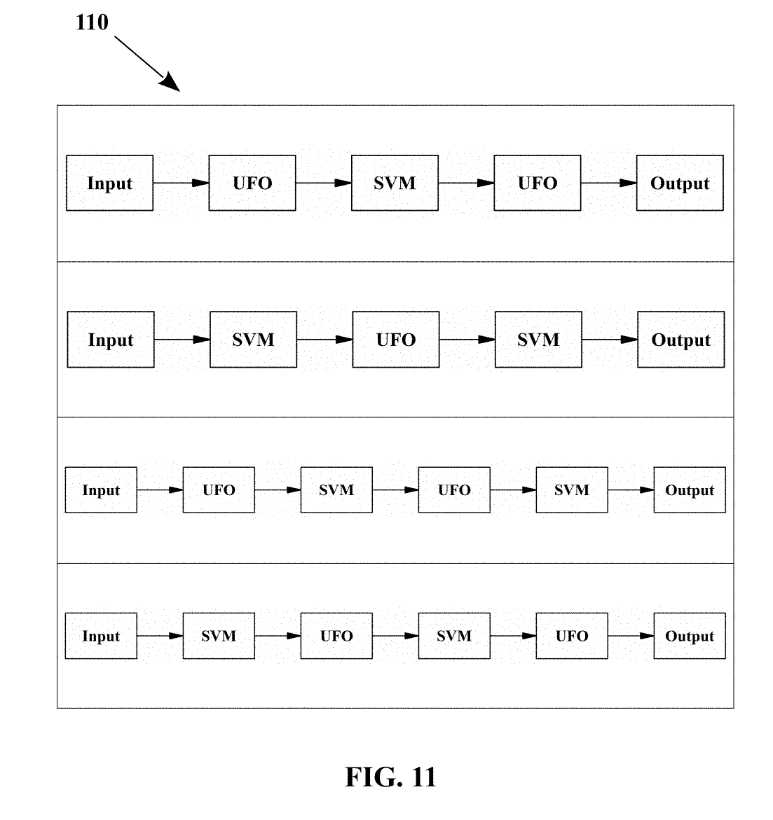

Actually, there are many other hybrid designs can be made between UFO and SVM. Some of these designs are shown in 110 of FIG. 11.

Instead of hybridizing UFO with SVM, ANNs can be involved here. One of the possible hybrid designs between UFO and ANNs is shown in 90 of FIG. 9, where the ANNs part is 91 and the estimated response is 92. This structure could reduce the complexity of neural networks by shifting all the non-linearity of the data to the UFO part. Thus, a simple shallow neural network could compete with a deep neural network. Also, it has to be said that any one of ANN types, including those listed in the paragraph number [0005], can be placed in 91 of FIG. 9.

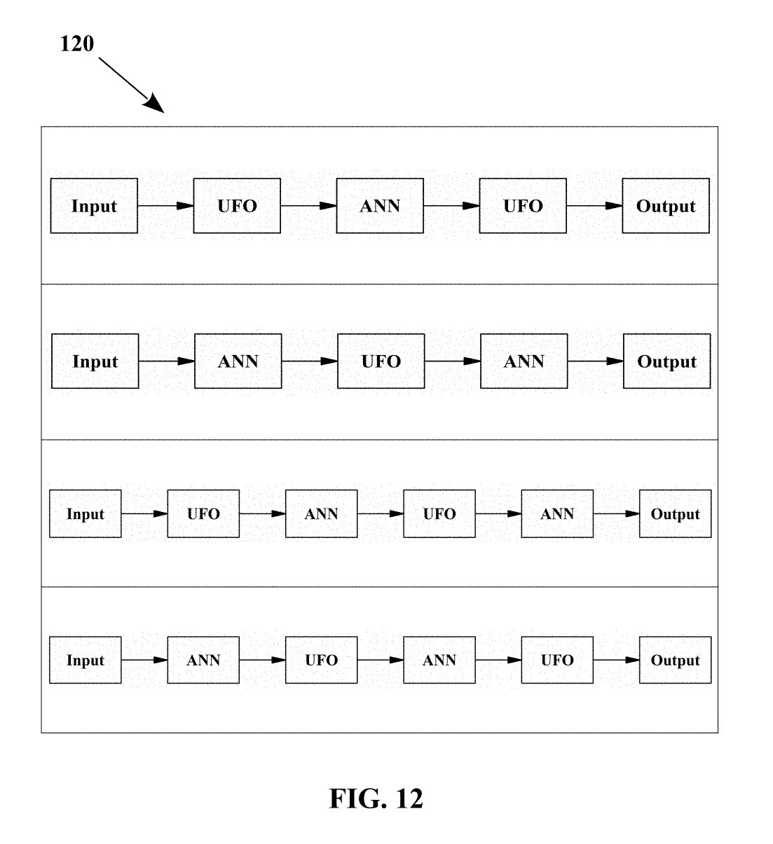

Similar to SVM, there are many possible hybrid designs between UFO and ANNs. Some of these designs are shown in 120 of FIG. 12.

Furthermore, UFO can be hybridized with both SVMs and ANNs. One of the possible hybrid designs is shown in 100 of FIG. 10. Thus, the capabilities of the three computing systems can be combined together to have a superior computing system.

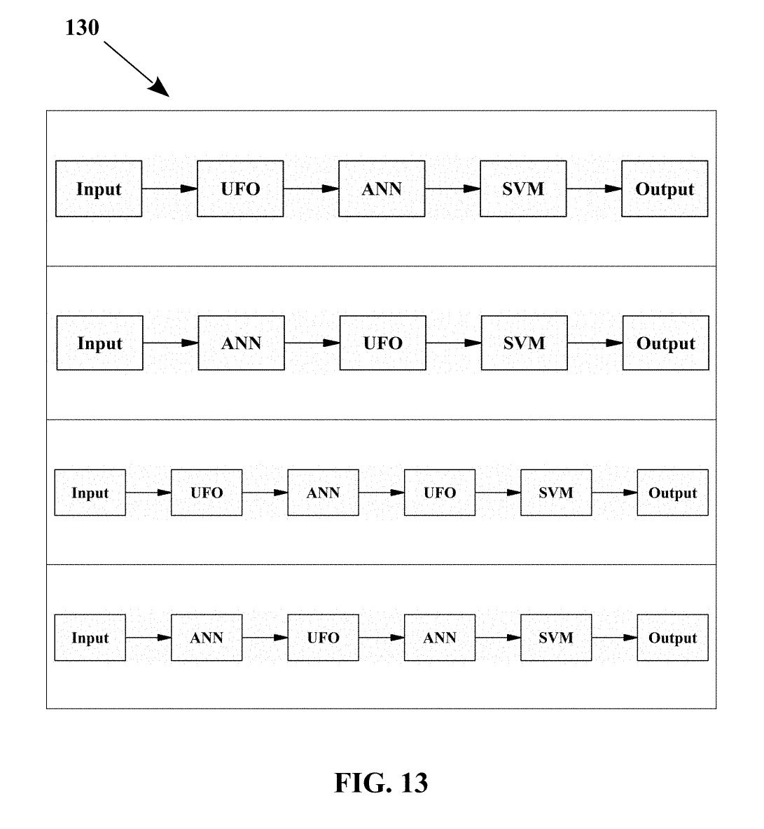

The other possible hybrid designs between these three computing systems are shown in 130 of FIG. 13.

The other computing system presented in the literature, including those listed in the paragraph number [0008], could be hybridized with UFO using the same preceding concepts.

For all the pure and hybrid UFO designs, there are different criteria can be used to measure their performance, such as: mean squared error (MSE), mean absolute error (MAE), root mean squared error (RMSE), mean absolute percentage error (MAPE), coefficient of determination (R²), coefficient of correlation (R), etc.

If UFO is used as a simplifer, then a further simplification unit can be placed before displaying the final results. This unit can search for any possible mathematical simplification. For example, if UFO produces 1−sin²(χ), then this unit can simplify these two terms to cos²(χ).

Conversely, a further complication unit can be placed if UFO acts as a complicator. For example, the function cos²(χ) can be complicated to 1−sin² (χ), then to 1−cos²(χ)+cos(2χ). By continuing the complication process, the preceding function can be further complicated to

$$1 - cos ( 2 x ) - {sin}^{2} ( x ) + \frac{1 - {tan}^{2} ( x )}{1 + {tan}^{2} ( x )} ,$$

till reaching to

$$1 - cos ( 2 x ) - {sin}^{2} ( x ) + \frac{2 tan ( x ) cot ( 2 x )}{2 - 2 tan ( x ) cot ( 2 x )} .$$

Thus, even if UFO can generate highly complicated mathematical equations, this extended unit can add a lot of superstitious complications before displaying the final results.

1. A computing system, comprising:
at least one row and multiple blocks, wherein the basic form of each block represents an individual mathematical equation comprising at least an external weight, an external exponent, an intercept, internal weights, internal exponents, internal universal arithmetic operators, and a function, wherein each two blocks are connected by an external universal arithmetic operator;
an initialization stage to define the parameters of said the computing system and two embedded global mixed-integer and local gradient-based optimization algorithms, which includes the number and types of said functions, the number and types of said the internal and external universal arithmetic operators, the number of rows and blocks used in said the computing system, the lower and upper limits of each variable used in said blocks, the number of iterations, the optimization stopping criteria, the types of design constraints, the types of constraint-handling techniques, and the types of said global mixed-integer and local gradient-based optimization algorithms;
a building stage that uses said global mixed-integer optimization algorithm to heuristically build many mathematical equations through a random selection process of functions, arithmetic operators, and coefficients;
a tuning stage that uses said local gradient-based optimization algorithm to tune some or all the mathematical equations generated in said the building stage, wherein the best or even all the tuned said mathematical equations can be recycled again in the next iteration of said the building stage; and
a testing and validation stage to evaluate the performance obtained in said the building stage and said the tuning stage, wherein the original data can be split into three parts for training, testing, and validation purposes to solve the over-fitting issue.

2. The basic model of each said block of claim 1 has the ability to generate almost infinite number of mathematical equations by varying the values and types of said the external weight, said the external exponent, said the intercept, said the internal weights, said the internal exponents, said the internal universal arithmetic operators, and said the function.

3. The basic forms of said the mathematical equations of claim 2 are expressed by multiplying said the external weight by said the function.

4. The function of claim 3 is a dependent variable, comprising at least said the intercept, said the internal weights, and said the internal exponents.

5. The intercept and said the internal weights of claim 4 are mathematically connected through said the internal universal arithmetic operators.

6. The internal weights of claim 5 are multiplied by their corresponding predictors, wherein said the predictors comprises of said the internal exponents.

7. Additional internal functions can be embedded in the place of said the external weight, said the external exponent, said the intercept, said the internal weights, and said the internal exponents used in each said block of claim 2 for more advanced structures of said the computing system.

8. The basic mathematical equations of claim 2 can be replaced with other more advanced mathematical expressions.

9. The computing system of claim 1 can be used to perform many applications, including function approximation, estimation, regression, prediction, forecasting, clustering, categorization, anomaly detection, mathematical simplification, mathematical complication, and high-dimensional problem visualization.

10. There are many differences between said the computing system and other known computing systems, such as:
the neurons of artificial neural networks contain only normalized weights and biases, wherein said the computing system comprises of said the external weights, said the intercepts, said the internal weights, said the internal exponents, said the external exponents, and said the functions;
wherein said the internal exponents can be defined as float or discrete values to normalize said the predictors to equal one when said the internal exponents equal zero;
wherein said the external exponents can be defined as float or discrete values to make the entire said blocks equal their said external weights when the external exponents equal zero;
wherein said the internal weights can be defined as float or discrete values to completely disable the terms of said the predictors when their said internal weights equal zero;
wherein said the external weights can be defined as float or discrete values to completely disable said the blocks when their said external weights equal zero;
wherein the nodes of said artificial neural networks must be connected between each others, which is an optional feature in said the computing system;
wherein said the computing system uses two different optimization algorithms in said the building stage and said the tuning stage, while said artificial neural networks use only one optimization algorithm in their training stage;
wherein said the tuning stage of said the computing system can be temporarily or permanently switched off if said the local gradient-based optimization algorithm fails to improve the complicated said mathematical equations generated in said the building stage;
wherein said artificial neural networks act as black-boxes, while said the computing system can represent its knowledge in said mathematical equations; and
once the data size is defined, the dimensions of said the global mixed-integer and local gradient-based optimization algorithms of said the computing system are affected by only the number of said the blocks, while said artificial neural networks are easily affected by the number of hidden layers and the number of said the neurons associated in each said hidden layer.

11. The output of each leading said block of said the computing system of claim 1 can be recycled again to the lagging said blocks located in different said rows, to have a recurrent structure of said the computing system.

12. The computing system of claim 1 can act as said mathematical simplification unit if one or few number of said blocks are used.

13. The computing system of claim 1 can act as said mathematical complication unit if many said blocks are used.

14. The computing system of claim 1 can be extended by adding an additional simplification unit to do a further simplification on the terms of said the mathematical equations, wherein some said terms could be collected during the simplification process.

15. The computing system of claim 1 can be extended by an additional complication unit to do a further complication on the terms of said the mathematical equations, wherein some said terms could be expanded during the complication process.

16. Universal function transformation units can be established by re-arranging said the blocks of said the computing system of claim 1 to modify the original said predictors and change said the data size.

17. Methods of hybridizing universal function transformation units, said methods comprising:
different types of linear regression analysis;
different types of non-linear regression analysis;
different types of support vector machines;
different types of said artificial neural networks; and
different types of other machine learning algorithms.

18. The universal function transformation units of claim 15 can be used to reduce the dimension of objective functions and constraints of high-dimensional optimization problems by considering the output of said the blocks as the values of new independent variables, wherein the number of said the blocks should be less than said the dimension of said high-dimensional optimization problems.

19. The dimension reduction of claim 18 can be used to visualize high-dimensional functions in two-dimensional plots if only one said block is used as an independent variable of said mathematical equations generated by said the computing system, and animated said two-dimensional plots can also be visualized by using two said blocks wherein the second said block is used as a time variable.

20. The dimension reduction of claim 18 can be used to visualize high-dimensional functions in three-dimensional plots if only two said blocks are used as two independent variables of said mathematical equations generated by said the computing system, and animated said three-dimensional plots can also be visualized by using three said blocks wherein said the time variable is defined as the output of the third said block.
